(19) United States
(12) Patent Application Publication
(10) Pub. No.: US 2024/0279445 A1
(43) Pub. Date: Aug. 22, 2024

(54) SURFACE PROTECTION LAYERS OBTAINED BY ADDITIVE MANUFACTURING

(71) Applicant: NOVACEL, DEVILLE-LÈS-ROUEN (FR)

(72) Inventors: Jean-Loup MASSON, BOIS-GUILLAUME (FR); Fanny SCHAPMAN, SAHURS (FR); Mylène LE BORGNE, ROUEN (FR); Julien BENARD, DÉVILLE-LÈS-ROUEN (FR)

(21) Appl. No.: 18/291,615

(22) PCT Filed: Jul. 25, 2022
(86) PCT No.: PCT/FR2022/051497

§ 371 Date: Jan. 24, 2024

(30) Foreign Application Priority Data
Jul. 26, 2021 (FR) FR2108109

(51) Int. Cl. C08L 23/06; B29C 64/118; B29K 23/00; B29K 25/00; B29K 105/00; B29K 105/16; B33Y 10/00; B33Y 70/00

(52) U.S. Cl. CPC C08L 23/06; B29C 64/118; B33Y 10/00; B33Y 70/00; B29K 2023/06; B29K 2023/08; B29K 2023/083; B29K 2025/08; B29K 2105/0085; B29K 2105/0094; B29K 2105/16; B29K 2995/0063; B29K 2995/007; B29K 2995/0082

(57) ABSTRACT

The present invention relates to a composition comprising 60 to 100% by weight of a polyolefin or polyolefin blend having a density between 0.85 and 0.92 g/cm³, a melt flow Index between 5.0, 20.0 g/10 min, a Shore A hardness between 70 and 90 and a flexural modulus greater than 10 MPa. Such a composition is useful for the temporary protection of objects or articles using the additive manufacturing technique.

### FIELD OF THE INVENTION

The invention relates to the field of surface protection. More specifically, the invention relates to the composition of a filament for additive manufacturing, capable of being used to form a surface protective film. The invention also relates to a process for coating the surface of an object, by additive manufacturing, using such a filament. The invention also relates to an object coated with a surface protective film deposited by additive manufacturing.

### STATE OF THE ART

Currently, in the surface protection industry, films are manufactured by extrusion or co-extrusion. These films are subsequently coated with glue and finally calendered on smooth and flat plates. These plates with the protective film can be used as is or transformed by cutting, folding, stamping, thermoforming to obtain, for example, sinks, bathtubs, refrigerators, etc. There are also liquid protection solutions, such as varnishes applied by spray or other coating techniques.

The fused filament deposition technique (“Fused Filament Fabrication (FFF)” or else “Fused Deposition Modeling (FDM)”) is described in U.S. Pat. No. 5,121,329. This technique falls into the category of multilayer additive manufacturing and has the particularity of using an extrusion system as a dispensing head. Indeed, a filament of solid materials and a diameter suitable for the printer is here melted at 1° C. above its solidification point. The fluid obtained is deposited on the tray and solidifies upon contact. In this way, the material is deposited in multilayers following a pre-drawn model. The last layer deposited must be solidified before depositing the next one and the new layer must adhere to the previous one. The deposition thickness is defined by the space between the tray and the dispensing head. The latter is moved in the axis z to control the thickness. The pattern is obtained by moving the tray in the axes x-y. A CAD/CAM system (computer-aided design/computer-aided manufacturing) controls these movements to follow the pre-recorded model. Now, extrusion temperatures can be well above the solidification point depending on the materials. For good print quality, the first layer of melted filament should adhere to the print tray. For this purpose, the tray is generally heated or covered with a primer solution. The movement systems can also vary depending on the printers. The aforementioned patent specifies that the filaments can be based on beeswax, thermoplastic resins, metals or else a metal alloy. The primary qualities of these materials are that they can melt at a predefined temperature and can quickly solidify without creating distortions.

FFF is mainly used to manufacture 3D articles for various applications such as automotive, aeronautics, medical etc. Polylactic acid (PLA) is the most common material for FFF printing because it has a low melting point (150° C.-160° C.) and therefore involves low energy consumption. Its mechanical properties are also in high demand for rigid and solid articles. There is work on the deposition of adhesive layers or surface functionalization by FFF. Patent application WO 2021/028795 proposes the use, for FFF printing, of filament based on pressure sensitive adhesive (PSA) to permanently adhere two surfaces. The PSAs in question are (meth)acrylate polymers with a Tg<20° C. and low hardness. This document highlights the fact that PSAs cannot be used as such in FFF. Their overly sticky surface is in fact not compatible with the filament feed system. A layer of polyolefin must be deposited on the surface of the filament to make the filament non-sticky. The printer used has a screw in its extrusion head in order to mix the filament obtained. The use of PSA-based filaments is also described in applications EP-A-3 680 301 and WO 2020/127348. Patent application WO 2020/114963 describes the functionalization of a film by FFF. This film is then placed on the surface of a 3D object to modify its surface and also provide protection.

Due to their great flexibility or their ability to absorb shock, thermoplastic elastomers (TPE) have appeared in FFF manufacturing to produce flexible objects. Shoes, sports equipment, automobile/aeronautical parts, toys, phone or tablet cases are thus produced by additive manufacturing. However, the printing of TPE by FFF is not as obvious as for very rigid materials. The most rigid and high-density TPEs are often very crystalline and non-polar, which generates warping and delamination between layers. For low density and very flexible TPEs, the filament fails to fulfill its role as a piston and bends instead of pushing the melted material through the extrusion head. To avoid this problem, it is therefore recommended to use a low extrusion speed and to use a printer where the motor and the extruder are connected in “direct drive” or a printer combining “direct drive” and “Bowden” (direct drive and Bowden extruders are commonly used for FFF printing). TPEs can also lack hardness and prevent the spools from rolling properly or be damaged by the teeth of the filament feed system. These impacts lead to shortages of material which are found in the printed product. This phenomenon is called buckling effect. Patent application WO 2021/037593 proposes to cool any filament before entering the extrusion head to impose sufficient hardness and rigidity for the duration of printing.

Polyolefins like polyethylene and polypropylene are the largest volumes produced by the plastics industry. In general, they have low density and are light and flexible. For manufacturing via FFF, polyolefins, however, suffer from their crystalline and apolar nature which limits their inter-layer adhesion and generates distortions. As it solidifies, the material accumulates stress which it compensates for by contracting. Several patents have proposed overcoming this problem, for example by adding a certain percentage of amorphous polyolefin polymers. Amorphous polymers do not accumulate stress as they solidify and are less sensitive to temperature change during the process. However, they have a low flexural modulus that is insufficient for most 3D articles. Patent application WO 2020/096718 proposes an additive manufacturing process which consists in depositing successive layers of a thermoplastic material comprising an olefinic block copolymer. It is shown that manufacturing using low or very low density polyethylene does not work. Patent application WO 2020/028013 proposes an additive manufacturing process using a blend of high density polyethylene and a second thermoplastic polymer selected from a low density polyethylene in a ratio (1.5/1 to 20/1). Patent application WO 2020/106172 describes a filament composition for 3D printing which comprises (i) 40 to 55% by weight of a crystalline isotactic polypropylene homopolymer, (ii) 13 to 28% by weight of an ethylene copolymer and a C₄-C₁₀ alpha-olefin, (iii) 27 to 32% by weight of one or more statistical ethylene copolymer(s) and a C₃-C₁₀ alpha-olefin, and (iv) at most 0.5% by weight of a nucleating agent and/or other additives. Patent application WO 2018/144141 proposes a composition for additive manufacturing comprising a thermoplastic polymer and an inorganic additive capable of reducing the specific heat of the composition (generated by the thermoplastic polymer). Patent application GB 2 515 348 proposes an additive manufacturing process using a polymer of variable rigidity, in particular a polymer with a Tg<10° C. The biggest difficulty with polymers having such a low Tg is that they deform under their own weight at room temperature and therefore during printing. To overcome this problem, the proposed solution consists in placing the 3D printer in a cooling chamber, thus the polymer remains solidified and resistant during printing.

None of these documents describes or suggests a filament composition for additive manufacturing by fused filament deposition, which mainly comprises a polyolefin or polyolefin blend meeting specific specifications in terms of density, melt flow index, a Shore A hardness and flexural modulus, these specifications allowing the use of said composition to form a very thin protective film on an object or article already manufactured.

The state of the art summarized above shows that there is currently no satisfactory solution to address the problems of temporary surface protection by additive manufacturing. There is therefore a need to be able to have compositions or filaments which allow to obtain, by additive manufacturing, in particular by FFF, temporary surface protection layers or films having, among others:
good adhesion to all types of surfaces at room temperature, without the need for a primer solution;
and good peelability, while being free from the phenomenon of warping and buckling.

It is with these specifications in mind that the present invention has been made.

### SUMMARY OF THE INVENTION

According to a first aspect, the invention relates to a filament composition for additive manufacturing by fused filament deposition, which comprises:
a) from 60 to 100% by weight of a polyolefin or polyolefin blend having (i) a density, measured according to the standard ISO1183, between 0.85 and 0.92 g/cm³, (ii) a melt flow index, measured according to the standard ASTM D1238 (190° C./2.16 kg) between 5.0 and 20.0 g/10 min, (iii) a Shore A hardness, measured according to the standard ISO 48-4:2018, between 70 and 90, and (iv) a flexural modulus, measured according to the standard ISO-178, greater than 10 MPa;
b) from 0 to 40% by weight of a compound selected from a styrene-ethylene-butylene-styrene copolymer, a styrene-butadiene-styrene copolymer, a styrene-isoprene-styrene copolymer, a styrene-isoprene-butadiene-styrene copolymer, a styrene-isobutylene-styrene copolymer, a styrene-ethylene-propylene-styrene copolymer, a styrene-ethylene-ethylene-propylene-styrene copolymer, an ethylene-styrene copolymer, an ethylene and vinyl acetate copolymer, an ethylene and acrylic derivative copolymer and blends of these compounds;
c) from 0 to 15% by weight of at least one tackifying resin;
d) from 0 to 10% by weight of at least one additive selected from matting agents, slip agents, dyes, UV stabilizers, UV barriers, antioxidants, anti-blocking agents and blends thereof;
   the sum of a), b), c) and d) is equal to 100%.

The filament obtained from blend a), b), c) and d) has the following properties: (i) a density, measured according to the standard ISO1183, between 0.85 and 1.10 g/cm³, (ii) a melt flow index, measured according to the standard ASTM D1238 (190° C./2.16 kg) between 5.0 and 20.0 g/10 min, (iii) a Shore A hardness, measured according to the standard ISO 48-4:2018, between 70 and 90, and (iv) a flexural modulus, measured according to the standard ISO-178, greater than 10 MPa.

According to another aspect, the invention relates to a process for coating, by additive manufacturing by fused filament deposition, the surface of an object or an article with at least two protection layers, said process comprising the following steps:
(i) heating and extruding a filament as defined below through a nozzle to form an extrudate,
(ii) distributing the extrudate through the nozzle while moving the latter so as to have a horizontal movement between the surface and the nozzle according to a predetermined pattern to form a first protection layer on the surface of the object or the article,
(iii) raising the nozzle along the vertical axis z and repeating step (ii) to form at least one additional layer.

According to another aspect, the invention relates to an object or an article coated with at least two protection layers by implementing the aforementioned process.

### BRIEF DESCRIPTION OF THE FIGURE

FIG. 1 schematically shows the operating principle of a 3D printer.

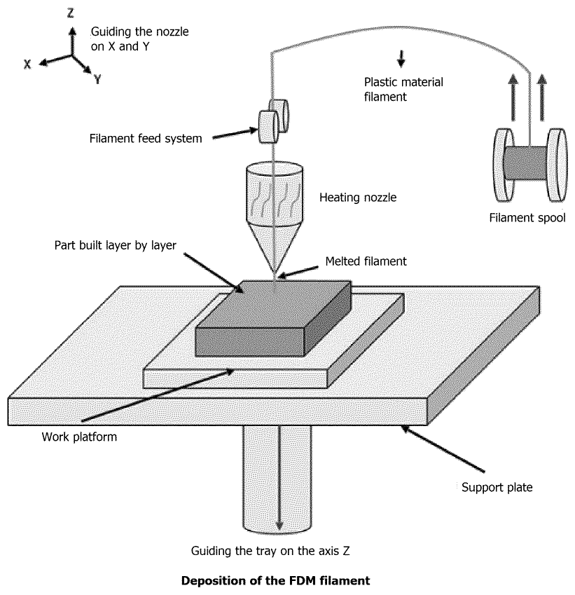

### DESCRIPTION OF THE INVENTION

A first aspect of the invention relates to a filament composition for additive manufacturing by fused filament deposition, which comprises:
a) from 60 to 100% by weight of a polyolefin or polyolefin blend having (i) a density, measured according to the standard ISO1183, between 0.85 and 0.92 g/cm³, (ii) a melt flow index, measured according to the standard ASTM D1238 (190° C./2.16 kg) between 5.0 and 20.0 g/10 min, (iii) a Shore A hardness, measured according to the standard ISO 48-4:2018, between 70 and 90, and (iv) a flexural modulus, measured according to the standard ISO-178, greater than 10 MPa; 25
b) from 0 to 40% by weight of a compound selected from a styrene-ethylene-butylene-styrene copolymer, a styrene-butadiene-styrene copolymer, a styrene-isoprene-styrene copolymer, a styrene-isoprene-butadiene-styrene copolymer, a styrene-isobutylene-styrene copolymer, a styrene-ethylene-propylene-styrene copolymer, a styrene-ethylene-ethylene-propylene-styrene copolymer, an ethylene-styrene copolymer, an ethylene and vinyl acetate copolymer, an ethylene and acrylic derivative copolymer and blends of these compounds;
c) from 0 to 15% by weight of at least one tackifying resin;
d) from 0 to 10% by weight of at least one additive selected from matting agents, slip agents, dyes, UV stabilizers, UV barriers, antioxidants, anti-blocking agents and blends thereof;
   the sum of a), b), c) and d) is equal to 100%.

For all practical purposes, it is specified here that the expression “the sum of a), b), c) and d) is equal to 100%” means that in all circumstances the cumulative amounts of a), b), c) and d) must be equal to 100%. Thus, for example, if the amount of a) is 70%, the cumulative amounts of b), c) and d) must be equal to 30%. In this case the amount of b) can therefore be at most equal to 30% (no c) nor d) in the filament composition).

The filament obtained from the blend a), b), c) and d) has the following properties: (i) a density, measured according to the standard ISO1183, between 0.85 and 1.10 g/cm³, (ii) a melt flow index, measured according to the standard ASTM D1238 (190° C./2.16 kg) between 5.0 and 20.0 g/10 min, (iii) a Shore A hardness, measured according to the standard ISO 48-4:2018, between 70 and 90, and (iv) a flexural modulus, measured according to the standard ISO-178, greater than 10 MPa.

In the present description, the expression “comprised between x and y” must be interpreted as including the end values of the considered range (that is to say, x and y).

The different embodiments and/or preferred variants of the invention can be combined.

In some embodiments, the polyolefin a) is selected from a radical polyethylene (PEr), a linear polyethylene (linear PE), a polypropylene (PP), an ethylene and propylene copolymer (EPM), an ethylene-propylene-diene copolymer (EPDM), advantageously from a linear polyethylene and an ethylene and propylene copolymer. In some embodiments, the polyolefin a) is selected from a radical polyethylene (PEr) or a linear polyethylene (linear PE), and is advantageously a linear polyethylene.

A “polyolefin blend” comprises, within the meaning of the present invention, either a blend of several polyolefins of the same type (for example, a blend of two linear PEs), or of one or more polyolefin(s) of a first type with one or more polyolefin(s) of one or more other types (for example, a blend of linear PE and radical PE). The polyolefin (taken individually) or the polyolefin blend a) must meet the above criteria, namely:
a density, measured according to the standard ISO1183, between 0.85 and 0.92 g/cm³;
a melt flow index, measured according to the standard ASTM D1238 (190° C./2.16 kg) between 5.0 and 20.0 g/10 min;
a Shore A hardness, measured according to the standard ISO 48-4:2018, between 70 and 90; and
a flexural modulus, measured according to the standard ISO-178, greater than 10 MPa.

In other words, when component a) is a polyolefin blend, it is the blend as such which must meet the aforementioned criteria.

In some embodiments, the linear PE is a copolymer of ethylene and a C₃-C₈ olefin monomer, such as propene, butene, hexene, methylpentene or octene.

In some embodiments, the PEr and the linear PE are either metallocene or Ziegler-Natta catalysis.

In some embodiments, the EPM has a propylene content between 25 and 60% by weight.

In some embodiments, the EPDM has a propylene content in the range of 25 to 60% by weight and a diene content, such as 1,4-hexadiene or ethylidiene norbornene, less than or equal to 6% by weight.

As polyolefin capable of being used in the context of the invention, mention may be made of the resins of the QUEO range marketed by the company Boréalis, the resins of the Engage range marketed by the company DOW and the resins of the Exact range marketed by the company ExxonMobil or else the resins of the Vistamaxx Performance range marketed by the company ExxonMobil.

Compound b) is selected from a styrene-ethylene-butylene-styrene copolymer (SEBS), a styrene-butadiene-styrene copolymer (SBS), a styrene-isoprene-styrene copolymer (SIS), a styrene-isoprene-butadiene-styrene copolymer (SIBS), a styrene-isobutylene-styrene copolymer (SiBS), a styrene-ethylene-propylene-styrene copolymer (SEPS), a styrene-ethylene-ethylene-propylene-styrene copolymer (SEEPS), an ethylene-styrene copolymer (ES), an ethylene and vinyl acetate copolymer (EVA), an ethylene-acrylic derivative copolymer (EDA) and blends of these compounds. “Blend of these compounds” means within the meaning of the present invention a blend of several copolymers of the same type, or of one or more copolymer(s) of a first type with one or more copolymer(s) of one or more other types.

In some embodiments, compound b) is selected from a styrene-ethylene-butylene-styrene copolymer (SEBS), a styrene-butadiene-styrene copolymer (SBS), a styrene-ethylene-propylene-styrene copolymer (SEPS), a styrene-ethylene-ethylene-propylene-styrene copolymer (SEEPS), an ethylene-styrene copolymer (ES), an ethylene-vinyl acetate copolymer (EVA), and blends of these compounds. Advantageously, compound b) is a SEBS. In some embodiments, the SEBS, the SBS, the SIS, the SIBS, the SiBS, the SEPS and the SEEPS each independently have a styrene content less than or equal to 50% by weight, preferably between 5 and 45% by weight.

In some embodiments, the SEBS, the SBS, the SIS, the SIBS, the SIBS, the SEPS and the SEEPS each independently have a diblock rate SEB, SB, SI, SIB, SIB, SEP and SEEP less than or equal to 70% by weight.

In some embodiments, the ES have a styrene content between 5 and 85% by weight. In some embodiments, the ES have a melt flow index, measured according to the standard ASTM D1238 (190° C./2.16 kg), between 0.1 and 40 g/10 min.

In some embodiments, the EVAs have a vinyl acetate content less than or equal to 80% by weight, and a melt index, measured according to the standard ASTM D1238 (190° C./2.16 kg), between 0.1 and 40 g/10 min.

In some embodiments, the EDAs preferably have an acrylic derivative content, such as for example butyl acrylate and/or (meth)acrylic acid, such as for example butyl acrylate and/or (meth)acrylic acid, less than or equal to 40% by weight.

In some embodiments, component a) is a blend of polyolefin(s) as defined above, for example a blend of linear PE and a copolymer as defined above, for example a copolymer selected from a SEBS, an SBS, a SEPS, a SEEPS, an ES, an EVA and blends thereof, advantageously the copolymer is a SEBS. In these embodiments, the weight ratio between component a) and component b) is advantageously in the range from approximately 60/40 to approximately 95/5, for example in the range from approximately 70/30 to approximately 90/10. It will therefore be understood that in the case of a blend of polyolefin(s) and copolymer(s), the polyolefin(s) is(are) predominantly present in the blend.

As compound b) capable of being used in the context of the invention, mention may be made of the products of the Kraton range marketed by the company Kraton Polymers, the products of the SEPTON™ and HYBRAR™ ranges marketed by the company Kuraray.

In some embodiments, the at least one tackifying resin c) is a thermoplastic resin, of low molecular weight, which is natural or synthetic, or non-hydrogenated, totally or partially hydrogenated or in a blend, in particular in C5 or C9 or a blend of C5/C9, a cyclic diolefin (C5)₂, or else a derivative of rosin (polymerized, hydrogenated, esterified or else dismutated rosin).

In some embodiments, the at least one additive d) is selected from matting agents, antioxidant agents (primary or secondary) and anti-aging agents. In some embodiments, the matting agents are either matting agents incompatible with PE, for example acrylic grafted polyethylenes or polyethylene salts, or anti-blocking agents, for example silica and its derivatives, talc and its derivatives, mica and its derivatives. In some embodiments, the anti-aging agents are sterically hindered amines also called HALS (from “Hindered Amine Light Stabilizers”). In the context of the invention, it is possible to use several additives of the same type.

In some embodiments, the filament composition in accordance with the invention is free of compound b) and therefore comprises:
a1) from 75 to 100% by weight of a polyolefin or polyolefin blend having (i) a density, measured according to the standard ISO1183, between 0.85 and 0.92 g/cm³, (ii) a melt flow index, measured according to the standard ASTM D1238 (190° C./2.16 kg) between 5.0 and 20.0 g/10 min, (iii) a Shore A hardness, measured according to the standard ISO 48-4:2018, between 70 and 90, and (iv) a flexural modulus, measured according to the standard ISO-178, greater than 10 MPa;
b1) from 0 to 15% by weight of at least one tackifying resin;
c1) from 0 to 10% by weight of at least one additive selected from matting agents, slip agents, dyes, UV stabilizers, UV barriers, antioxidants, anti-blocking agents and blends thereof;
the sum of a1), b1) and c1) is equal to 100% (and the polyolefin or the polyolefin blend a1) are as defined above for component a), the tackifying resin b1) is as defined above for the tackifying resin c), and the additives c1) are as defined above for the additives d)).

The filament obtained from the blend a1), b1) and c1) has the following properties: (i) a density, measured according to the standard ISO1183, between 0.85 and 0.92 g/cm³, (ii) a melt flow index, measured according to the standard ASTM D1238 (190° C./2.16 kg) between 5.0 and 20.0 g/10 min, (iii) a Shore A hardness, measured according to the standard ISO 48-4:2018, between 70 and 90, and (iv) a flexural modulus, measured according to the standard ISO-178, greater than 10 MPa.

The filaments in accordance with the invention can be prepared according to processes known to the person skilled in the art.

In some embodiments, the filaments have a diameter comprised between about 1.50 mm and about 3.50 mm, for example a diameter equal to 1.75 mm, 2.85 mm or 3.25 mm depending on the 3D printer used.

The filaments in accordance with the invention can be used to coat (and temporarily protect) the surface of objects or articles manufactured using the additive manufacturing technique by fused filament deposition.

Another aspect of the invention thus relates to a process for coating, by additive manufacturing by fused filament deposition (by means of a 3D printer), the surface of an object or article with at least two protection layers, said process comprising the following steps:
(i) heating and extruding a composition as defined above through a nozzle to form an extrudate,
(ii) distributing the extrudate through the nozzle while moving the latter so as to have a horizontal movement between the surface and the nozzle according to a predetermined pattern to form a first layer on the surface of the object or the article,
(iii) raising the nozzle along a vertical axis (the axis z of the 3D printer) and repeating step (ii) to form at least one additional layer.

In other words, the aforementioned process is a process for protecting an object or manufactured article by depositing, by additive manufacturing by fused filament deposition, at least two layers of protective film on the surface of said object or manufactured article.

In some embodiments, step (iii) is repeated up to 10 times, for example 1 time, 2 times, 3 times, 4 times, 5 times, 6 times, 7 times, 8 times, 9 times or 10 times. In some embodiments, step (iii) is repeated three times. It is understood that when step (iii) is implemented for the first time, the “first” additional layer is deposited on the first layer formed in step (ii). When step (iii) is repeated each additional layer is deposited on the layer immediately formed previously.

In some embodiments, each of the layers formed by additive manufacturing has a thickness comprised between 40 micrometers and 500 micrometers, for example between 40 micrometers and 200 micrometers, between 50 micrometers and 200 micrometers, or between 50 micrometers and 100 micrometers. In some embodiments each of the layers formed has the same thickness. In some embodiments, at least two of the layers formed have a thickness distinct from one another.

The assembly of layers deposited on the surface of an object or article to be protected forms a temporary protective film. This temporary protective film has a peeling force, measured at a detachment speed of 300 mm/min, comprised between 0.1 and 300 N/m, preferably between 0.1 and 150 N/m, more preferably between 0.5 and 100 N/m.

The deposition of different (temporary) protection layers on the surface of an object or article is carried out with a 3D printer by fused filament deposition. This printer has its motor and extrusion head connected in “direct drive”. The filament is heated by the extrusion head to a temperature comprised between about 185° C. and about 230° C. and deposited on a tray at room temperature. The diameter of the exit nozzle of the extrusion head is typically 0.4 mm, but other diameters are possible depending on the nature of the object or article to be protected. The first layer is generally deposited at low speed (for example 10 mm/sec) until a thickness comprised between 40 and 500 μm is obtained. For the following layer(s), the deposition speed is increased (for example 20 mm/sec) to obtain a layer thickness comprised between 40 and 300 μm.

The implementation of the aforementioned process allows to protect different objects or manufactured articles due to the formation of at least two layers on their surface. This protection is temporary because the layers formed can be removed easily without leaving unwanted residue on the surface in question.

Thus, another aspect of the invention relates to an object or a manufactured article coated with at least two protection layers by implementing the fused filament deposition process described above. In some embodiments, the object or article is coated with two to twelve protection layers, preferably two to five protection layers.

In some embodiments, the surface of the object or manufactured article is a plastic surface, in particular a surface in the form of plates (for example PMMA, PC, PVC, etc.), a pre-coated surface (for example a pre-lacquered, laminated surface, etc.), a laminate, a wooden surface, a plastic profile, a bare metal (aluminum, stainless steel).

The filament compositions according to the invention allow to form, by additive manufacturing by fused filament deposition, protection layers on the surface of objects which combine high flexibility, good adhesion to the surface, good peelability, while avoiding the buckling effects during printing. The person skilled in the art will understand that depending on the nature of the filament formed from the composition according to the invention, one or more types of surface (as defined above) may be protected.

The implementation of the invention allows to deposit at least two thick protection layers directly on the surface to be protected following more or less complex surface models. Thanks to the FFF technique and its modeling systems, it is possible to protect curved, structured, rough surfaces and 3D objects, in particular luxury products (watches, jewelry, etc.) requiring great complexity and precision on the area to be protected.

The invention is illustrated by the following examples, given purely for illustrative purposes.

### Example 1

Different compositions were tested for their ability to be produced in the form of filaments (spinning). When filaments were formed, they were wound into a spool. The unwinding and rewinding capacity of the spools was evaluated (winding). The results are presented in Table 1.

TABLE 1

| | | | Melt flow | | | | |
|---|---|---|---|---|---|---|---|
| | | | Index | | Flexural | | |
| | | Density | (g/10 min, | Hardness | modulus | | |
| Composition | Nature | (g/cm³) | 190° C./2.16 kg) | (Shore A) | (MPa) | Spinning | Winding |
| ENGAGE ™ | Linear | 0.857 | 1 | 54 | 4.5 | NO | — |
| 8842 | PE | | | | | | |
| QUEO ™ 0201 | Linear | 0.902 | 1.1 | 93 | 72 | NO | — |
| | PE | | | | | | |
| Versaflex ™ | SEBS | 0.920 | 17 | 37 | — | NO | — |
| MD6649 | | | | | | | |
| Vistamaxx ™ | PP | 0.862 | 9.1 | 64 | 13 | NO | — |
| 6202 | | | | | | | |
| Versaflex ™ | SEBS | 0.910 | 4.5 | 49 | — | YES | NO |
| MD6741 | | | | | | | |
| QUEO ™ 8210 | Linear | 0.883 | 10 | 84 | 24 | YES | YES |
| | PE | | | | | | |
| Exact ™ 0210 | Linear | 0.902 | 10 | 88 | 65 | YES | YES |
| | PE | | | | | | |
| QUEO ™ 7007 | Linear | 0.870 | 6.6 | 71 | 8 | YES | YES |
| | PE | | | | | | |
| Exact ™ 0210/ | PE/SEBS | 0.902 | 7.7 | 79 | — | YES | YES |
| Kraton ™ | | | | | | | |
| G1657M | | | | | | | |
| 80/20 | | | | | | | |
| QUEO ™ 8210/ | PE/PP | 0.879 | 9.2 | 65 | — | YES | YES |
| Vistamaxx ™ | | | | | | | |
| 6202 | | | | | | | |
| 80/20 | | | | | | | |
| Exact ™ 0210/ | PE/EVA | 0.912 | 7.9 | 88 | — | YES | YES |
| Escorene ™ | | | | | | | |
| FL00728CC | | | | | | | |
| 80/20 | | | | | | | |

The first four compositions of the table could not be spun. Among the other compositions, which could be spun, all the filaments formed could be unwound and rewound into a spool, with the exception of those obtained from Versaflex™ MD6741 because they were too sticky.

### Example 2

The filaments that passed the winding test were subjected to a printing test. Printing was done with a Stream 30 Dual MK2 printer from Volumic. For each filament tested, the temperature of the extrusion head was optimized between 185° C. and 260° C. The temperature of the printing tray was adjusted between 25 and 90° C. The first layer was deposited at a lower speed of 10 mm/sec to form a layer thickness between 100-200 μm. For the second layer, the deposition speed was increased to 20 mm/sec and the layer thickness was between 100-200 μm. Strips of 2 cm×12 cm were thus formed. The filaments were evaluated on their print grip onto the surface without adhesion primer and on a good filling of the printed strip.

Filaments based on QUEO™ 7007 and based on the QUEO™ 8210/Vistamaxx™ 6202 blend were not compatible with the fused filament printing process. The filaments obtained were too flexible to be inserted into the feed system and to ensure their role as a piston in the printer.

Printing with filaments based on Exact™ 0210, QUEO™ 8210, Exact™ 0210/Kraton™ G1657M and Exact™ 0210/Escorene™ FL00728CC gave good surface adhesion and filling.

### Example 3

Strips were printed on different types of surfaces (metals, pre-lacquered, plastics, glasses, etc.) and tested as a protection layer. For each type of surface, one test was carried out on the surface at room temperature and another on the surface heated by a tray at 90° C. To pass the test successfully, the strips must adhere to the surface, be easily detachable and have good mechanical strength. These characteristics were evaluated manually and by measuring detachment forces at a peeling speed of 300 mm/min. The manual peel test involves removing the applied film by hand. This test is considered negative in cases where the film: (i) detaches prematurely, (ii) has a strong deformation, (iii) breaks during peeling, (iv) damages the surface to be protected or (v) has a too high adhesion. The detachment forces are measured using a dynamometer. The detachment forces should be comprised between 0.1 and 300 N/m to meet the needs of surface protection.

Some examples are shown in Table 2.

TABLE 2

| | | | Detachment force |
|---|---|---|---|
| Printed | Surface to be | Manual | (at 300 mm/min, in N/m) |
| composition | protected | peel test | (surface at 25° C.) |
| QUEO 8210 | Stainless steel | + + | 0.7 |
| | (Ra¹ = 2.5) | | |
| | Aluminum GB | + + | 1.6 |
| | Bare glass | + + | 1.5 |
| | Pre-painted | + + | 1.6 |
| | PMMA | + + | 0.5 |
| | Polycarbonate | + + | 1.6 |
| Exact 0210 | Stainless steel | + | — |
| | (Ra = 2.5) | | |
| | Aluminum GB | + | — |
| | Bare Glass | − − | — |
| | Pre-painted | − | — |
| | PMMA | + | — |
| | Polycarbonate | + + | 8.5 |
| Exact 0210/ | Stainless steel | + | — |
| Kraton^{R} | (Ra = 2.5) | | |
| G1657M | Aluminum GB | + | — |
| 80/20 | Bare glass | + + | 1.0 |
| | Pre-painted | + + | 1.6 |
| | PMMA | + + | 8.6 |
| | Polycarbonate | + + | 17 |
| Exact ™ 0210/ | Stainless steel | + + | 1.3 |
| Escorene ™ | (Ra = 2.5) | | |
| FL00728CC | Aluminum GB | − | — |
| 80/20 | Bare glass | − | — |
| | Pre-painted | + + | 6.1 |
| | PMMA | + + | 55 |
| | Polycarbonate | − | — |

¹Ra = surface roughness, measured according to the standard ISO 13565-2
+ + Good hold and peelability of the printed film on the surface at room temperature
+ Good hold and peelability of the printed film on the surface at 90° C. but not at room temperature
− Premature detachment, deformation or breakage of the film, damage to the surface or too much adhesion
− − Non-printable on the surface

The filaments based on QUEO 8210™ could be printed at room temperature on all surfaces tested and the film obtained offered good hold and peelability.

Filaments based on the Exact 0210™/Kraton™ G1657M blend could be printed at room temperature on all surfaces tested. For surfaces such as glass, pre-painted, PMMA and polycarbonate, the film obtained offered good hold and peelability.

Filaments based of the Exact 0210™/Escorene™ FL00728CC blend could be printed at room temperature on all surfaces tested. For stainless steel, pre-painted and PMMA surfaces, the film obtained offered good hold and peelability.

Filaments based on Exact 0210™ could be printed on surfaces such as stainless steel, aluminum and polycarbonate.

1. A filament composition for additive manufacturing by fused filament deposition, which comprises:
a) from 60 to 100% by weight of a polyolefin or polyolefin blend having (i) a density, measured according to the standard ISO1183, between 0.85 and 0.92 g/cm³, (ii) a melt flow index, measured according to the standard ASTM D1238 (190° C./2.16 kg) between 5.0 and 20.0 g/10 min, (iii) a Shore A hardness, measured according to the standard ISO 48-4:2018, between 70 and 90, and (iv) a flexural modulus, measured according to the standard ISO-178, greater than 10 MPa;
b) from 0 to 40% by weight of a compound selected from a styrene-ethylene-butylene-styrene copolymer, a styrene-butadiene-styrene copolymer, a styrene-isoprene-styrene copolymer, a styrene-isoprene-butadiene-styrene copolymer, a styrene-isobutylene-styrene copolymer, a styrene-ethylene-propylene-styrene copolymer, a styrene-ethylene-ethylene-propylene-styrene copolymer, an ethylene-styrene copolymer, an ethylene and vinyl acetate copolymer, an ethylene-acrylic derivative copolymer and blends of these compounds;
c) from 0 to 15% by weight of at least one tackifying resin;
d) from 0 to 10% by weight of at least one additive selected from matting agents, slip agents, dyes, UV stabilizers, UV barriers, antioxidants, anti-blocking agents and blends thereof;
the sum of a), b), c) and d) is equal to 100%.

2. The composition of claim 1, wherein said polyolefin is selected from a radical polyethylene and a linear polyethylene.

3. The composition of claim 1, wherein compound b) is selected from the group consisting of a styrene-ethylene-butylene-styrene copolymer, a styrene-butadiene-styrene copolymer, a styrene-ethylene-propylene-styrene copolymer, a styrene-ethylene-ethylene-propylene-styrene copolymer, an ethylene-styrene copolymer, an ethylene and vinyl acetate copolymer, and blends of these compounds.

4. The composition of claim 1, which comprises from 70% to 95% by weight of a polyolefin or polyolefin blend, and from 5% to 30% by weight of compound b).

5. The composition of claim 1, which comprises:
a1) from 75 to 100% by weight of a polyolefin or polyolefin blend having (i) a density, measured according to the standard ISO1183, between 0.85 and 0.92 g/cm³, (ii) a melt flow index, measured according to the standard ASTM D1238 (190° C./2.16 kg) between 5.0 and 20.0 g/10 min, (iii) a Shore A hardness, measured according to the standard ISO 48-4:2018, between 70 and 90, and (iv) a flexural modulus, measured according to the standard ISO-178, greater than 10 MPa;
b1) from 0 to 15% by weight of at least one tackifying resin;
c1) from 0 to 10% by weight of at least one additive selected from matting agents, slip agents, dyes, UV stabilizers, UV barriers, antioxidants, anti-blocking agents and blends thereof;
the sum of a1), b1) and c1) is equal to 100%.

6. The composition of claim 5, wherein said polyolefin is selected from a radical polyethylene and a linear polyethylene.

7. A filament obtained from the composition of claim 1, which has (i) a density, measured according to the standard ISO1183, between 0.85 and 1.10 g/cm³, (ii) a melt flow index, measured according to the standard ASTM D1238 (190° C./2.16 kg) between 5.0 and 20.0 g/10 min, (iii) a Shore A hardness, measured according to the standard ISO 48-4:2018, between 70 and 90, and (iv) a flexural modulus, measured according to the standard ISO-178, greater than 10 MPa.

8. A filament obtained from the composition of claim 5, which has (i) a density, measured according to the standard ISO1183, between 0.85 and 0.92 g/cm³, (ii) a melt flow index, measured according to the standard ASTM D1238 (190° C./2.16 kg) between 5.0 and 20.0 g/10 min, (iii) a Shore A hardness, measured according to the standard ISO 48-4:2018, between 70 and 90, and (iv) a flexural modulus, measured according to the standard ISO-178, greater than 10 MPa.

9. A method for coating, by additive manufacturing by fused filament deposition, the surface of an object or article with at least two protection layers, said process comprising the following steps:
(i) heating and extruding a composition as defined in claim 1 through a nozzle to form an extrudate,
(ii) distributing the extrudate through the nozzle while moving the latter so as to have a horizontal movement between the surface and the nozzle according to a predetermined pattern to form a first layer on the surface of the object or the article,
(iii) raising the nozzle along a vertical axis and repeating step (ii) to form at least one additional layer.

10. The method of claim 9, wherein step (iii) is repeated one to ten times.

11. The method of claim 9, wherein each layer formed has a thickness comprised between 40 micrometers and 500 micrometers.

12. The method of claim 11, wherein each of the layers formed has the same thickness.

13. The method of claim 11, wherein at least two of the layers formed have a thickness distinct from one another.

14. A manufactured object or article coated with at least two protection layers, said object or article being coated by the method of claim 9.

15. The manufactured object or article of claim 14, which is coated with two to twelve protection layers.

16. The manufactured object or article of claim 14, wherein each protection layer has a thickness comprised between 40 micrometers and 500 micrometers.

17. The composition of claim 1, which comprises:
a) from 70 to 95% by weight of a polyolefin or polyolefin blend having (i) a density, measured according to the standard ISO1183, between 0.85 and 0.92 g/cm³, (ii) a melt flow index, measured according to the standard ASTM D1238 (190° C./2.16 kg) between 5.0 and 20.0 g/10 min, (iii) a Shore A hardness, measured according to the standard ISO 48-4:2018, between 70 and 90, and (iv) a flexural modulus, measured according to the standard ISO-178, greater than 10 MPa;
b) from 5 to 30% by weight of a compound selected from a styrene-ethylene-butylene-styrene copolymer, a styrene-butadiene-styrene copolymer, a styrene-isoprene-styrene copolymer, a styrene-isoprene-butadiene-styrene copolymer, a styrene-isobutylene-styrene copolymer, a styrene-ethylene-propylene-styrene copolymer, a styrene-ethylene-ethylene-propylene-styrene copolymer, an ethylene-styrene copolymer, an ethylene and vinyl acetate copolymer, an ethylene-acrylic derivative copolymer and blends of these compounds;
c) from 0 to 15% by weight of at least one tackifying resin;
d) from 0 to 10% by weight of at least one additive selected from matting agents, slip agents, dyes, UV stabilizers, UV barriers, antioxidants, anti-blocking agents and blends thereof;
the sum of a), b), c) and d) is equal to 100%.

18. A method for coating, by additive manufacturing by fused filament deposition, the surface of an object or article with at least two protection layers, said process comprising the following steps:
(i) heating and extruding a composition as defined in claim 17 through a nozzle to form an extrudate,
(ii) distributing the extrudate through the nozzle while moving the latter so as to have a horizontal movement between the surface and the nozzle according to a predetermined pattern to form a first layer on the surface of the object or the article,
(iii) raising the nozzle along a vertical axis and repeating step (ii) to form at least one additional layer.

19. The method of claim 18, wherein step (iii) is repeated one to ten times.

20. A manufactured object or article coated with at least two protection layers, said object or article being coated by the method of claim 18.
